(19) United States
(12) Patent Application Publication
(10) Pub. No.: US 2026/0012927 A1
(43) Pub. Date: Jan. 8, 2026

(54) SMART SELECTION OF RESOURCES IN V2X COMMUNICATIONS

(71) Applicant: MEDIATEK INC., Hsinchu (TW)

(72) Inventors: Harshmeet Singh, Cambridge (GB); Jaakko Matias Viertola, Oulu (FI); Miquel Eduard Oliver Cardona, Cambridge (GB)

(21) Appl. No.: 18/761,845

(22) Filed: Jul. 2, 2024

(51) Int. Cl. H04W 72/02; H04W 72/0446; H04W 72/30; H04W 72/566

(52) U.S. Cl. CPC H04W 72/02; H04W 72/0446; H04W 72/30; H04W 72/566

(57) ABSTRACT

A UE determines a pool of resources for transmitting data from the UE to another UE over a number of time slots. The UE determines available resources from the pool of resources by excluding first one or more time slots from the number of time slots based on expected reception at the UE in the one or more time slots. The UE modifies the available resources by adding back a first set of time slots from the excluded time slots to the available resource based on a priority of the expected reception in the one or more time slots when a ratio of currently available resources to the pool of resources is less than a threshold. The UE transmits the data to the another UE on a resource selected from currently available resources of the pool.

### BACKGROUND

### Field

The present disclosure relates generally to wireless communications, and more particularly, to techniques of autonomous resource selection by a user equipment (UE) for sidelink vehicle-to-everything (V2X) communications that minimize overlap between the UE's transmissions and reception of higher-priority data from other UEs.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE determines a pool of resources for transmitting data from the UE to another UE over a number of time slots. The UE determines available resources from the pool of resources by excluding first one or more time slots from the number of time slots based on expected reception at the UE in the one or more time slots. The UE modifies the available resources by adding back a first set of time slots from the excluded time slots to the available resource based on a priority of the expected reception in the one or more time slots when a ratio of currently available resources to the pool of resources is less than a threshold. The UE transmits the data to the another UE on a resource selected from currently available resources of the pool.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating different UEs and their communication methods (broadcast, groupcast, unicast) in different Radio Access Technologies (RATs).

FIG. 8 is a diagram illustrating time and frequency resources available for a UE to autonomously select for transmission.

FIG. 9 is a diagram illustrating time and frequency resources available for a UE to autonomously select for transmission, and priorities of expected receptions in each time slot.

FIGS. 10(A) and 10(B) are a flow chart illustrating a procedure of a tiered strategy employed by a UE for determining available resources in a pool of communication resources for transmission.

FIG. 11 is a diagram illustrating data structures used by the UE to keep records of priorities and timeslots of transmissions and receptions at the UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

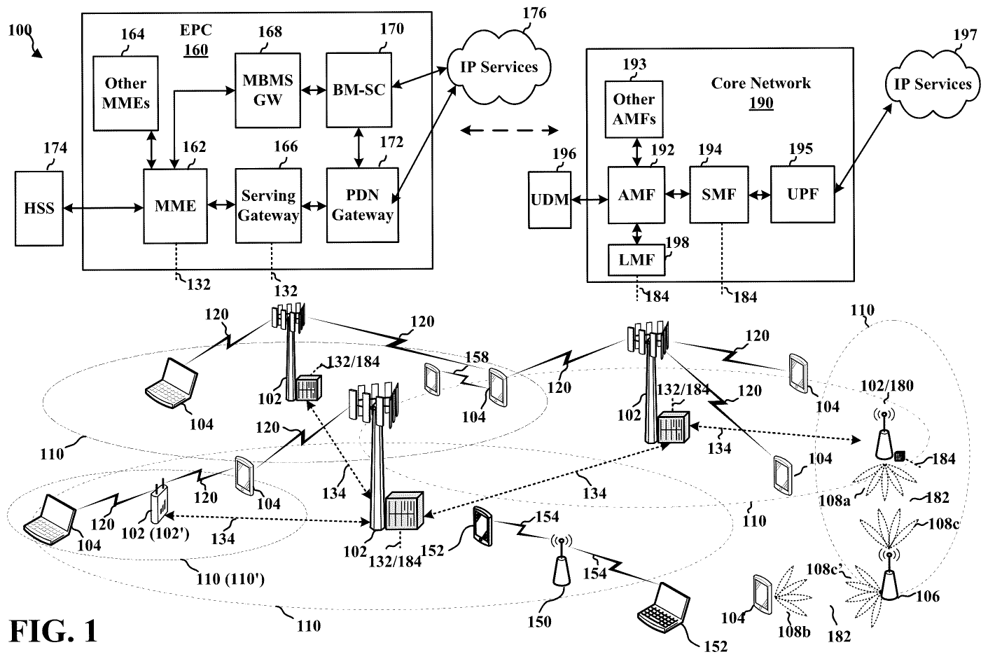

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mm W frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

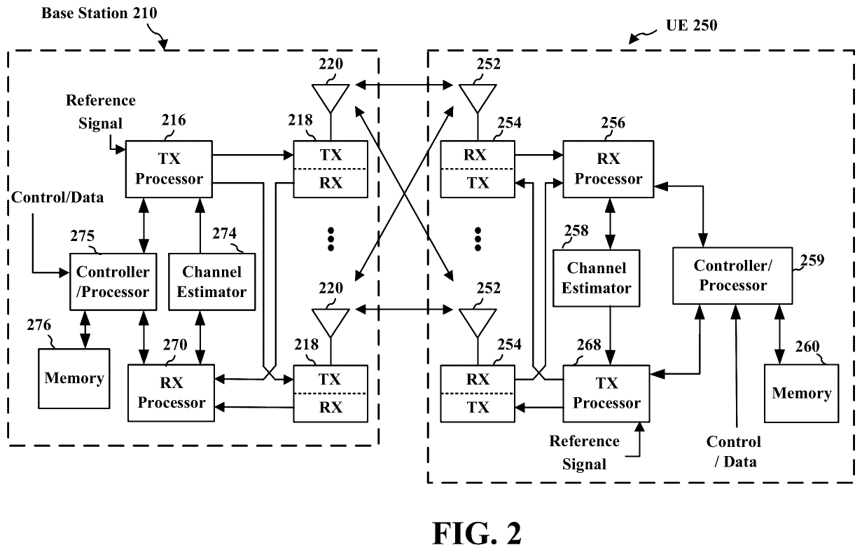

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

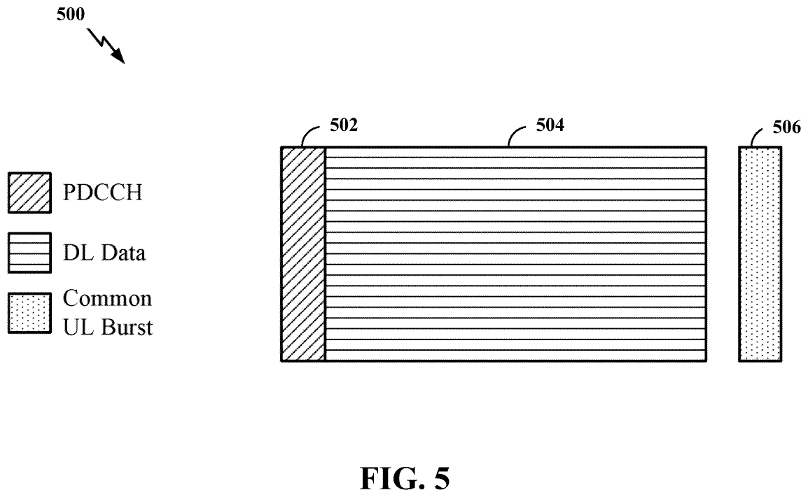

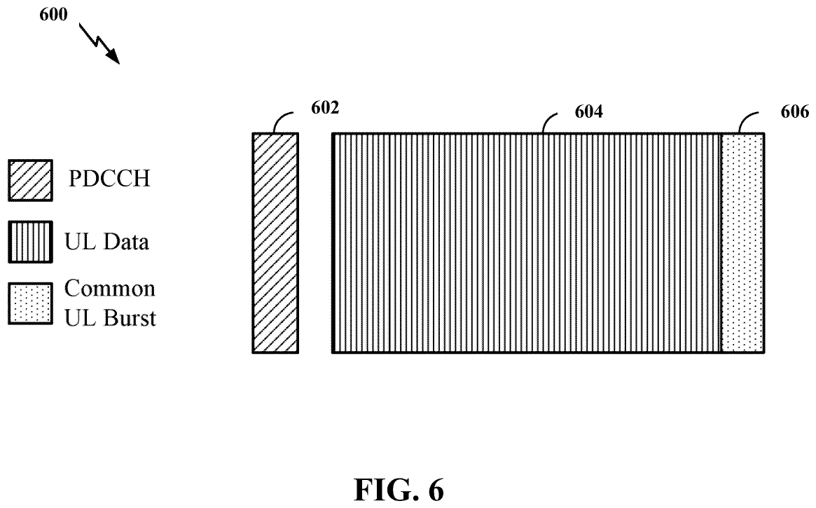

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

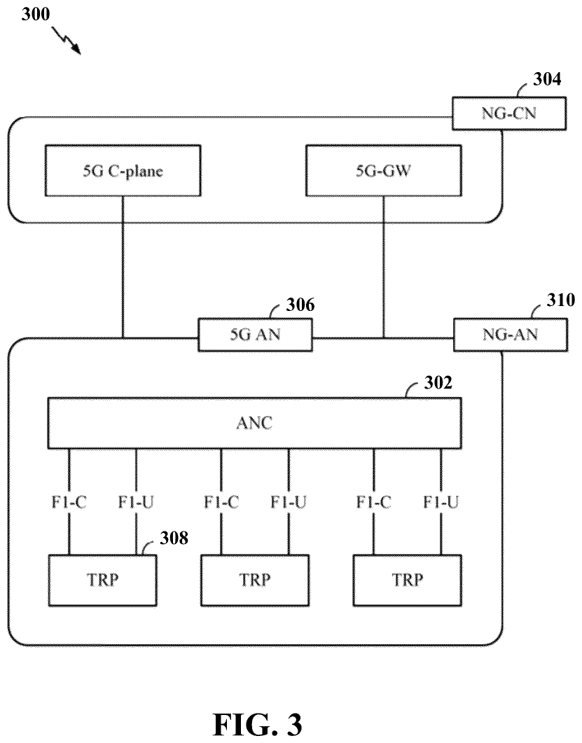

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

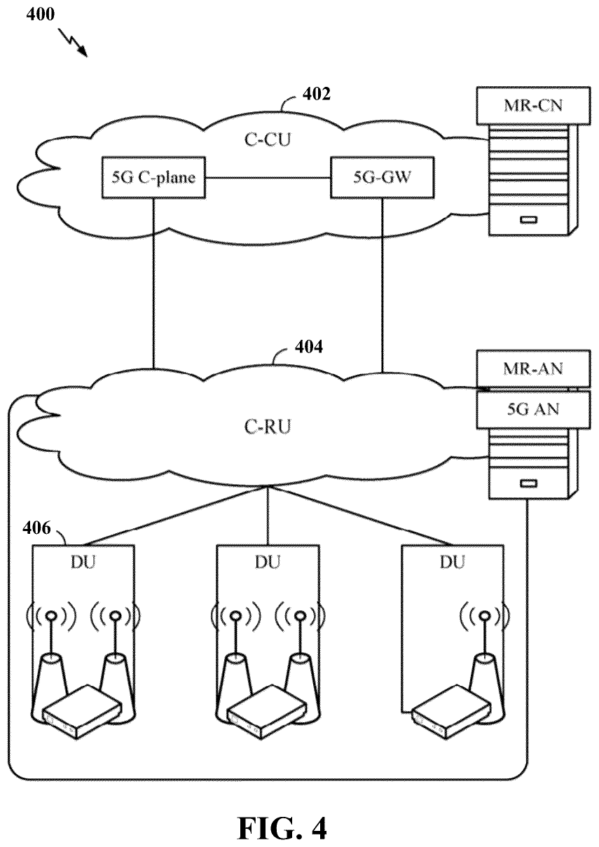

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

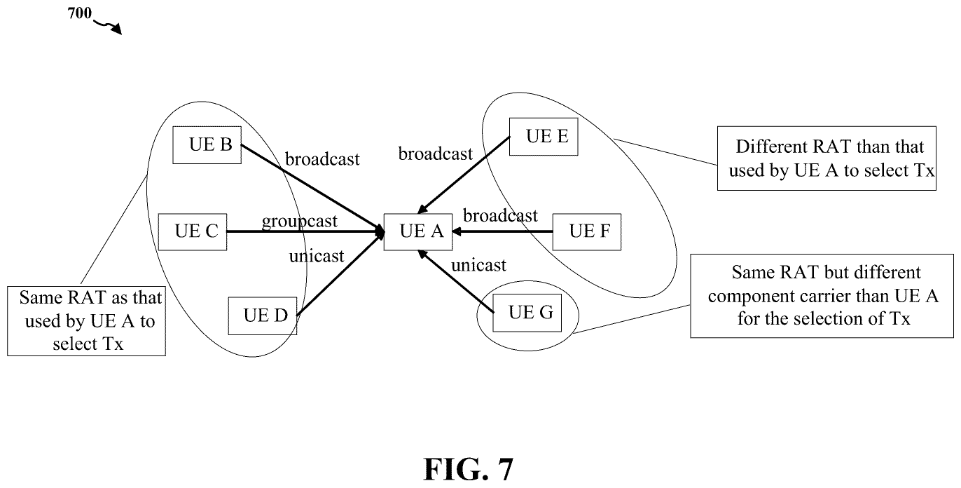

FIG. 7 is a diagram 700 illustrating different UEs and their communication methods (broadcast, groupcast, unicast) in different Radio Access Technologies (RATs) such as Long Term Evolution (LTE) and New Radio (NR). In this example, UE A is a multi-mode device supporting both NR V2X and LTE V2X. UEs B, C, and D are NR UEs operating on the same RAT as UE A. When UE A attempts to allocate resources for NR transmission, it may sense information on broadcast, groupcast, or unicast transmissions from these UEs. Simultaneously, UE A, being multi-mode, may receive broadcasts from LTE UEs E and F on a different RAT. Furthermore, UEs B, C, and D may operate on a different carrier than another NR UE G, adding carrier diversity to the environment. Each of the UEs may have a structure similar to that of the UE 250.

A UE does not select a resource that is already being used by another UE. This is typically addressed in 3GPP standards through sensing mechanisms that enable UEs to identify resources occupied by other UEs. For instance, UE A senses that UE B, C, and D are transmitting data via broadcast, groupcast, and unicast methods in NR. Similarly, it senses that UEs E and F are using LTE for broadcast communication, and UE G is utilizing NR on a different carrier. UE A, being multimode and capable of operating in both LTE and NR, would avoid selecting these occupied resources for its own transmissions.

Further, in certain configurations, a UE cannot transmit and receive data simultaneously due to the time-division multiplexing nature of the communication system. Therefore, the UE should select a time slot for transmission that does not coincide with time slots where it expects to receive transmissions from other UEs. In cases where overlap is unavoidable, the UE should prioritize its own transmissions over lower-priority transmissions from other UEs. That is, the overlapping transmission from the other UE is of lower priority than its own transmission. Furthermore, multiple transmit processes running simultaneously within the same UE do not overlap. As an example, if UE A has active periodic transmit processes, these processes should not collide with each other.

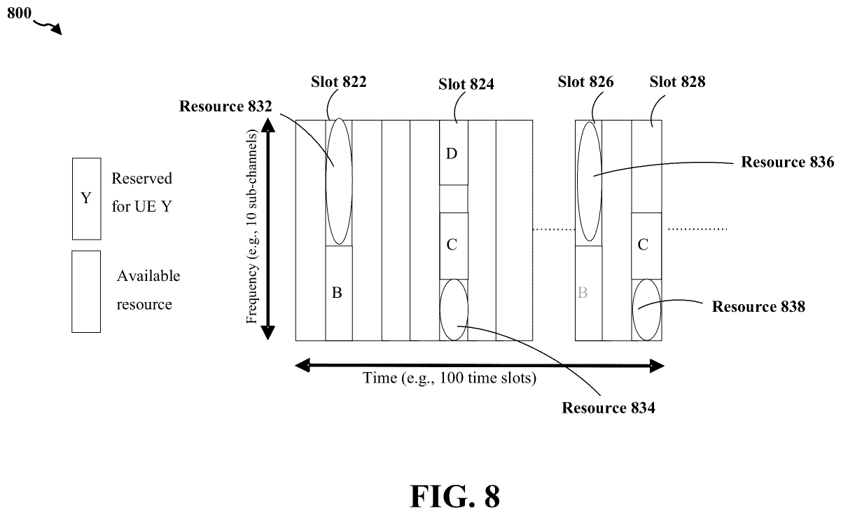

FIG. 8 is a diagram 800 illustrating the time and frequency resources available for the UE A to autonomously select for transmission. The vertical axis represents frequency, while the horizontal axis represents time. The UE A is not able to simultaneously transmit and receive data due to the time-division multiplexing nature of the communication system.

In this example, the slots 822, 824, 826, and 828 correspond to transmissions to the UE A from other the UEs B, C, and D, which the UE A has identified through sensing mechanisms. The slots 822, 824, 826, and 828 contains available resources 832, 834, 836, or 838, respectively.

If the UE A selects one of the available resources 832, 834, 836, or 838 for transmission, it will be unable to receive the corresponding transmissions from the UEs B, C, and D in the reserved slots. For instance, if the UE A chooses to transmit in the resource 832, it will miss the reception for a transmission from UE B in the slot 822. Similarly, transmitting in the resource 834 would cause the UE A to miss receptions for transmissions from the UEs D and C in the slot 824.

In a first scheme, there is no mechanism for the UE to avoid such conflicts between transmission and reception slots. In case of a clash, the UE always prioritizes transmission over reception, irrespective of the priority of the data being received. This results in the UE missing potentially important data from other UEs. For example, the UE A selecting transmit resources within the available resources 832, 834, 836, or 838 would be unable to receive transmissions from other UEs, such as the UEs B, C, and D, in the corresponding slots 822, 824, 826, or 828, respectively.

Therefore, there is a need for a scheme that enables the UE to intelligently select transmission resources in a way that minimizes the overlap with slots where it expects to receive data, especially high-priority data, from other UEs. The UE should be able to assess the priority and importance of the expected receptions and factor that into its decision-making process when selecting transmission resources. The UE can balance between transmitting its own data and receiving critical information from other UEs, thereby enhancing the overall efficiency and performance of the V2X communication system.

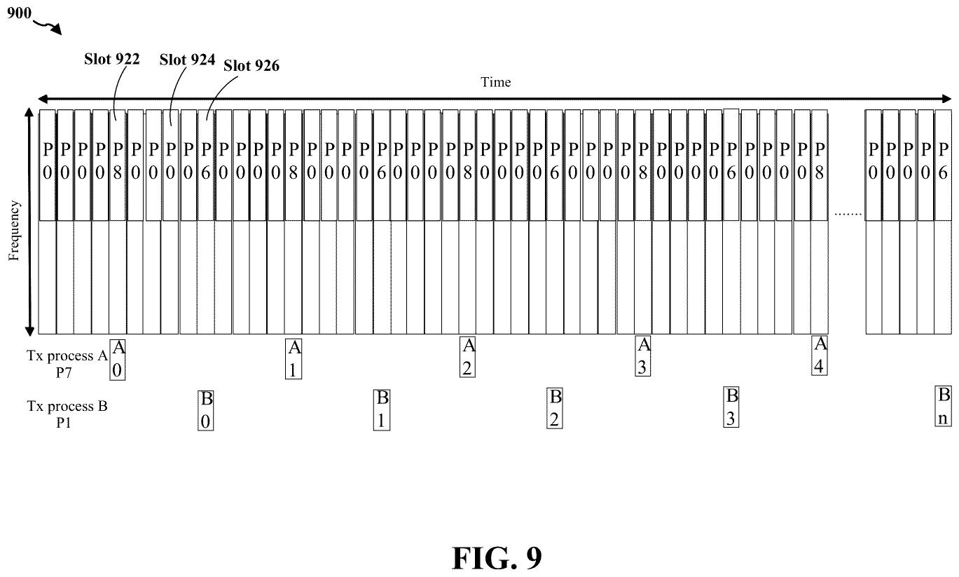

FIG. 9 is a diagram 900 illustrating the time and frequency resources available for the UE A to autonomously select for transmission, and the priorities of expected receptions in each time slot. The vertical axis represents frequency, while the horizontal axis represents time.

The UE A is aware of the priorities of expected receptions in each time slot through sensing mechanisms.

For example, UE A is expecting to receive a high-priority (P₀) transmission in the time slot 924. On the other hand, UE A expects a low-priority (P₈) reception in the time slot 922 and a medium-priority (P₆) reception in the time slot 926. P₀ represents the highest priority, and P₈ represents the lowest priority.

The UE A wants to select resources for two transmit processes, A and B. The transmit process A has a priority of P₇, while the transmit process B has a priority of P₁. These transmit processes do not overlap with each other in time. Further, a transmit process does not overlap with a reception of higher or equal priority. For instance, the transmit process A with priority P₂ does not overlap with any reception of priority P₀ through P₇. However, it can overlap with a time slot where the reception priority is lower than its own priority, such as the time slot 922 with priority P₈.

Similarly, the transmit process B, with priority P₁, can overlap with a reception of lower priority, such as the time slot 926 with a reception priority of P₆. However, it avoids overlapping with receptions of higher priority, such as the time slots having reception priority P₀.

In this second scheme, there is no time overlap between Tx resources from different Tx processes within the same UE, regardless of whether they are on the same or different Radio Access Technology (RAT) or frequency carrier. As such, the UE's own transmissions do not interfere with each other.

This second scheme prevents the overlap of the UE's Tx resources with periods designated for receiving higher priority data. This is achieved by the UE intelligently selecting Tx resources based on its awareness of the priorities of expected receptions in each time slot.

For example, in FIG. 9, the UE A has two transmit processes, A and B, with priorities P₂ and P₁, respectively. The transmit process B, with priority P₁, does not overlap with receptions of the highest priority P₀ in the time slot 924 (e.g., P₁>P₆, P₈ but P₁<P₀).

In contrast, FIG. 8 illustrates that in the first scheme, the UE A, if selecting transmit resources within the available resources 832, 834, 836, or 838, would be unable to receive transmissions from other UEs, such as the UEs B, C, and D, in the corresponding slots 822, 824, 826, or 828, respectively. This is because there is no mechanism in the first scheme for the UE to avoid conflicts between transmission and reception slots, and the UE always prioritizes transmission over reception, irrespective of the priority of the data being received.

The second scheme resolves this issue by enabling the UE to intelligently select transmission resources in a way that minimizes the overlap with slots where it expects to receive data, especially high-priority data, from other UEs. By assessing the priority and importance of the expected receptions and factoring that into its decision-making process when selecting transmission resources, the UE can balance between transmitting its own data and receiving critical information from other UEs, thereby enhancing the overall efficiency and performance of the V2X communication system.

In a first aspect of the second scheme, a V2X terminal (e.g., the UE A) supporting single or multi-carrier operation autonomously selects a communication resource for transmission in a manner that minimizes the chance of overlapping (in time or in both time and frequency) with other communication resources used by the V2X terminal to receive data that is directed to it by broadcast, unicast, or groupcast within the same wireless radio access technology. This addresses the problem illustrated in FIG. 8, where the UE A, if selecting transmit resources within the available resources 832, 834, 836, or 838, would be unable to receive transmissions from other UEs, such as the UEs B, C, and D, in the corresponding time slots 822, 824, 826, or 828, respectively. By minimizing the overlap between transmission and reception resources, the V2X terminal can effectively balance between transmitting its own data and receiving critical information from other UEs.

A second aspect of the second scheme extends the first aspect by considering received data that is directed to the V2X terminal from across different radio access technologies. The V2X terminal's transmission resources do not overlap with reception resources in both the same and different radio access technologies.

A third aspect of the second scheme enables a V2X terminal supporting single or multi-carrier operation to autonomously select a communication resource for transmission in a manner that avoids the overlap (in time or in both time and frequency) with other communication resources used by the V2X terminal to transmit on a different transmit process within the same wireless radio access technology. This prevents the V2X terminal's own transmissions from interfering with each other, as illustrated in FIG. 9, where the transmit processes A and B of the UE A do not overlap in time.

A fourth aspect of the second scheme extends the third aspect by considering different transmit processes used by the V2X terminal across different radio access technologies. The V2X terminal's transmit processes do not interfere with each other, regardless of the radio access technology they operate on.

In a first configuration of the second scheme, future time slots are reserved for reception of data regardless of data priority. A UE gathers sensing data and blocks or excludes any time slot where there is a reception from the pool of TX resources, solely based on the presence of a reception, irrespective of the priority of the data being received. For example, in FIG. 8, the UE A would reserve the time slots 822, 824, 826, and 828 for reception, and exclude the corresponding resources 832, 834, 836, and 838 from the pool of available TX resources, regardless of the priority of the data being received in those time slots.

In a second configuration of the second scheme, future time slots are reserved for the reception of data whose priority is higher than the data for which the transmitting resource is being selected. A UE reserves a time slot for data reception only if the priority of the expected data reception is higher than the priority of the TX data for which the UE is trying to select a resource. For instance, in FIG. 9, if the UE A is selecting a TX resource for data with priority P₇, it would reserve the time slot 924 for reception and not for transmission, as it expects to receive data with a higher priority P₀ in that time slot. However, it may reserve the time slots 922 for transmission and not for reception, as the expected data in those time slots have a priority (P₈) that is not higher than the TX data priority (P₇).

In a third configuration of the second scheme, a tiered strategy is employed. Initially, future time slots are reserved for reception of data regardless of data priority. If the number of candidate resources left for transmission falls below a certain threshold, the number of reserved slots is adjusted based on data priority and type of communication until the number of candidate resources for transmission exceeds the threshold. A UE first blocks all time slots where it expects any kind of data reception. However, if this results in insufficient resources for random selection in the TX pool, the UE starts putting some slots back into the TX resource pool. It begins by adding back those slots that contain receptions with a priority lower than the TX data for which it is trying to select a resource. This process of refining the reserved slots based on priority and communication type continues until the number of candidate TX resources is above the required threshold for random selection. This tiered approach dynamically adjusts the reservation criteria based on the available resources and TX data priority.

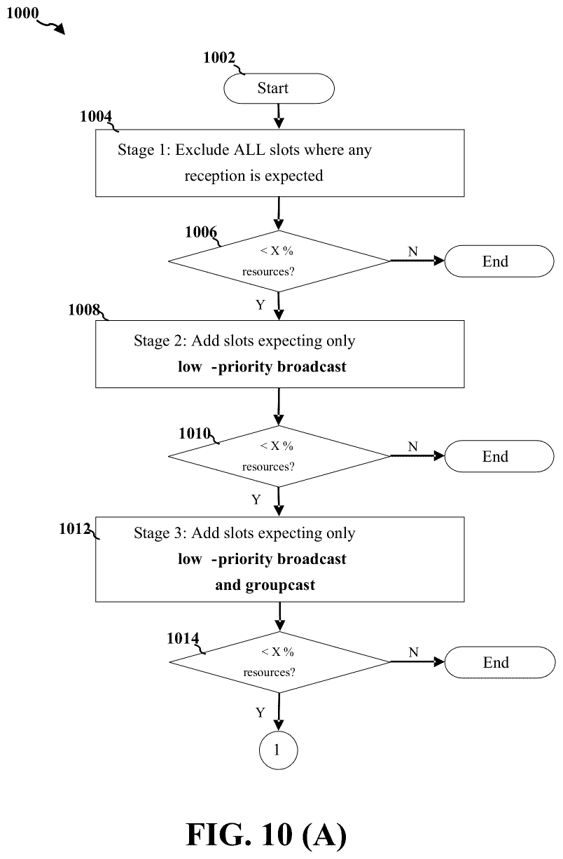

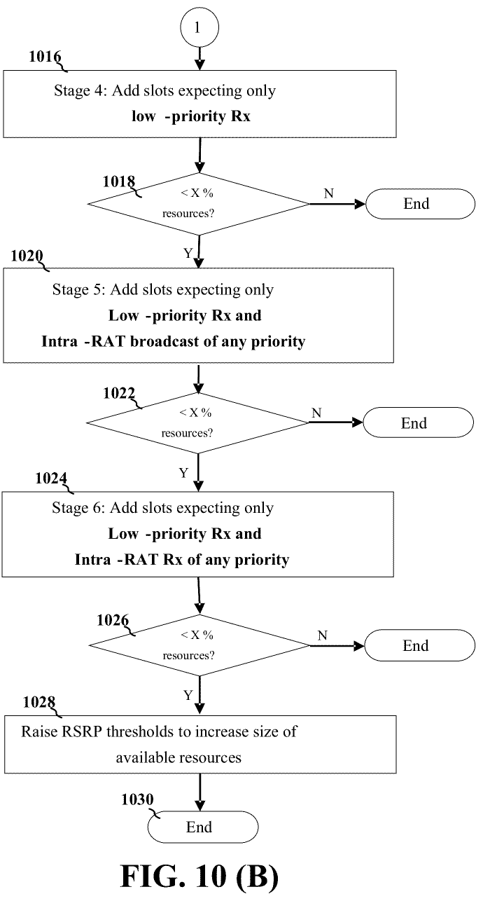

FIGS. 10(A) and 10(B) are a flow chart 1000 illustrating a procedure of a tiered strategy employed by a UE for determining available resources in a pool of communication resources for transmission while minimizing overlap with reception slots, especially those containing high-priority data.

A resource pool is a set of time-frequency resources available for a UE to autonomously select for transmission. The size of the resource pool is determined by the number of frequency channels (sub-channels) and the time dimension, which depends on the packet delay budget.

For example, in FIG. 8, the frequency dimension of the resource pool may include 10 sub-channels, which may be the same for every UE as it is part of the pre-configuration. The time dimension, on the other hand, depends on the packet delay budget. If a packet needs to be sent within 100 milliseconds and each slot is 1 millisecond, there would be 100 units in the time dimension. With 10 sub-channels in each time unit and 100 time units, the resource pool would contain a total of 1000 possible resources.

The resource pool may be different for each UE due to variations in the time domain, as the packet delay budget can vary. Another factor that makes the resource pool different for each UE is the number of resources required for one transmission, which depends on the amount of data the UE is trying to send and the modulation and coding scheme (MCS) used. For instance, one UE might use two contiguous resources for a transmission, while another UE might use four or just one resource. This also contributes to the differences in the resource pool among UEs in the frequency domain.

A UE autonomously selects a transmission resource from the available resource pool, while attempting to minimize overlap with slots where it expects to receive data, especially high-priority data, from other UEs. A UE selects its transmission resource using the procedure illustrated in FIG. 10. The UE determines a pool of resources available for transmission. The UE then refines the available pool of resources by excluding resources based on the priority and type of expected reception in each time slot.

In this example, the initial pool of available resources for transmission by the UE A includes all resources available without consideration of reception at the UE A. In the example of FIG. 8 having 10 sub-channels and 100 time units, the initial resource pool contains a total of 1000 resources. In operation 1004, corresponding to Stage 1, the UE excludes all the time slots from the initial pool of available resources if it is expecting any reception in those time slots, regardless of the priority, cast type (e.g., broadcast, groupcast, or unicast), RAT, or carrier. In operation 1006, the UE checks if the percentage of available resources in the pool is less than a predefined threshold X % (e.g., 20%).

The percentage of available resources is calculated based on the total number of resources in the pool and the number of resources that are not excluded by the UE's selection criteria. Referring to FIG. 8, the total number of resources in the pool is determined by the number of frequency sub-channels and the number of time slots. In this example, there are 10 frequency sub-channels and 100 time slots, resulting in a total of 1000 resources in the pool.

Initially, in Stage 1 of the selection procedure, the UE A excludes all the time slots from the pool of available resources if it is expecting any reception in those time slots, regardless of the priority, cast type, RAT, or carrier. This means that the UE A excludes the time slots 822, 824, 826, and 828, along with their corresponding resources 832, 834, 836, and 838, from the pool of available resources.

Assuming that each of the time slots 822, 824, 826, and 828 contains 10 resources (one for each frequency sub-channel), a total of 40 resources are excluded from the pool in Stage 1. This leaves 960 resources available out of the total 1000 resources, resulting in 96% of the resources being available.

If the percentage of available resources (96% in this example) is greater than or equal to the threshold X % (e.g., 20%), the selection procedure ends, and the UE A can select a resource from the available pool for transmission. Otherwise, the procedure proceeds to operation 1008.

In operation 1008, corresponding to Stage 2, the UE modifies its exclusion criteria and adds back into the pool those time slots that are only occupied by broadcast messages with a lower priority than the intended transmission. In operation 1010, the UE checks if the percentage of available resources is less than X %. If it is, the procedure advances to operation 1012. If not, the procedure ends.

In operation 1012, corresponding to Stage 3, the UE further refines the exclusion criteria by adding back those time slots that contain only broadcast and groupcast messages with lower priority than the intended transmission. For example, referring to FIG. 9, if the UE A intends to transmit data with priority P₇, and the time slot 922 contains only a broadcast message with a lower priority P₈, the UE A would add back the time slot 922 to the pool of available resources in Stage 2. In operation 1014, the UE checks if the percentage of available resources is less than X %. If it is, the procedure advances to operation 1016. If not, the procedure ends.

In operation 1016, corresponding to Stage 4, the UE expands the pool of available resources by adding back those time slots that are only occupied by any type of message—broadcast, groupcast, or unicast—but with lower priority than the intended transmission. In operation 1018, the UE checks if the percentage of available resources is less than X %. If it is, the procedure advances to operation 1020. If not, the procedure ends.

In operation 1020, corresponding to Stage 5, the UE allows the Tx to occupy time slots containing expected receptions with priority equal to or higher than the intended transmission but only for intra-RAT scenarios. The UE starts by adding back those time slots that only contain expected broadcast receptions, regardless of their priority, while continuing to exclude those time slots with expected unicast or groupcast receptions of equal or higher priority. In operation 1022, the UE checks if the percentage of available resources is less than X %. If it is, the procedure advances to operation 1024. If not, the procedure ends.

In operation 1024, corresponding to Stage 6, the UE adds to the pool all time slots containing expected receptions with priority equal to or higher than the intended transmission for intra-RAT scenarios. At this point, the only time slots that remain excluded are those with expected higher-priority or equal priority reception on a different RAT. In operation 1026, the UE checks if the percentage of available resources is less than X %. If it is, the procedure proceeds to operation 1028. If not, the procedure ends.

In operation 1028, the UE raises the Reference Signal Received Power (RSRP) thresholds to increase the pool of available resources. This is consistent with the mechanism employed in the 3GPP standards such that a resource is available for transmission. After raising the RSRP thresholds, the procedure ends in operation 1030.

After the procedure ends, the UE selects a transmit resource from the available resource pool.

As shown in the flow chart, the tiered strategy includes six stages, each refining the exclusion criteria for time slots based on the percentage of available resources in the pool and the priority and type of expected receptions.

In Stage 1, the UE excludes all the time slots from the pool of available resources if it is expecting any reception in those time slots, regardless of the priority, cast type (e.g., broadcast, groupcast, or unicast), RAT, or carrier. This initial exclusion aims to minimize the overlap between transmission and reception slots.

If the percentage of available resources in the pool after Stage 1 is less than a predefined threshold X % (e.g., 20%), the UE proceeds to Stage 2. In Stage 2, the UE modifies its exclusion criteria and adds back into the pool those time slots that are only occupied by broadcast messages with a lower priority than the intended transmission. The assumption here is that broadcast messages of lower priority than the intended transmission might represent the least important messages, and the UE can afford to miss their reception.

If the available resources are still below the threshold X % after Stage 2, the UE moves to Stage 3, where it further refines the exclusion criteria by adding back those time slots that contain only broadcast and groupcast messages with lower priority than the intended transmission. This stage assumes that groupcast messages are less important than unicast messages.

If the available resources remain below the threshold after Stage 3, the UE proceeds to Stage 4, where it expands the pool of available resources by adding back those time slots that are only occupied by any type of message—broadcast, groupcast, or unicast—but with lower priority than the intended transmission.

If the threshold is still unattainable after Stage 4, the UE moves to Stage 5, where it allows the Tx to occupy time slots containing expected receptions with priority equal to or higher than the intended transmission, but only for intra-RAT scenarios. In this stage, the UE starts by adding back those time slots that only contain expected broadcast receptions, regardless of their priority, while continuing to exclude those time slots with expected unicast or groupcast receptions of equal or higher priority.

If the threshold remains unmet after Stage 5, the UE proceeds to Stage 6, where it adds to the pool all time slots containing expected receptions with priority equal to or higher than the intended transmission for intra-RAT scenarios. At this point, the only time slots that remain excluded are those with expected higher-priority or equal priority reception on a different RAT than that of the intended transmission.

If the percentage of available resources is still below the threshold after Stage 6, the UE raises the Reference Signal Received Power (RSRP) thresholds to increase the pool of available resources. Raising the RSRP thresholds makes the UE more selective in considering a signal as a valid reception, thereby reducing the number of time slots excluded from the pool of available resources.

After the procedure ends, the UE selects a transmit resource from the available resource pool, minimizing the chance of overlapping with reception slots, especially those containing high-priority data.

In the current embodiment described supra, Stage 5 adds back intra-RAT broadcast receptions of any priority, while Stage 6 adds back all intra-RAT receptions of any priority. However, in another embodiment, these stages can be split into more granular steps to consider the priority of the expected receptions more precisely.

The modified stages can be described as follows:
Stage 5A: Add back time slots containing intra-RAT broadcast receptions of equal priority to the intended transmission.
Stage 5B: Add back time slots containing intra-RAT receptions of any cast type (broadcast, groupcast, or unicast) with equal priority to the intended transmission.
Stage 6A: Add back time slots containing intra-RAT broadcast receptions of any priority.
Stage 6B: Add back time slots containing intra-RAT receptions of any cast type (broadcast, groupcast, or unicast) and any priority.

These modified stages provide a more gradual relaxation of the exclusion criteria, allowing the UE to prioritize the reception of critical information while still ensuring a sufficient number of resources for random selection.

In Stage 5A, the UE adds back time slots containing intra-RAT broadcast receptions of equal priority to the intended transmission. This step assumes that broadcast messages of equal priority to the intended transmission can be missed. Stage 5B further relaxes the criteria by adding back time slots containing intra-RAT receptions of any cast type (broadcast, groupcast, or unicast) with equal priority to the intended transmission. This step prioritizes the UE's own transmission over receptions of equal priority, regardless of the cast type.

Stage 6A adds back time slots containing intra-RAT broadcast receptions of any priority, as described in the current embodiment. Finally, Stage 6B adds back time slots containing intra-RAT receptions of any cast type (broadcast, groupcast, or unicast) and any priority. At this point, the only time slots that remain excluded are those with expected higher-priority or equal priority reception on a different RAT.

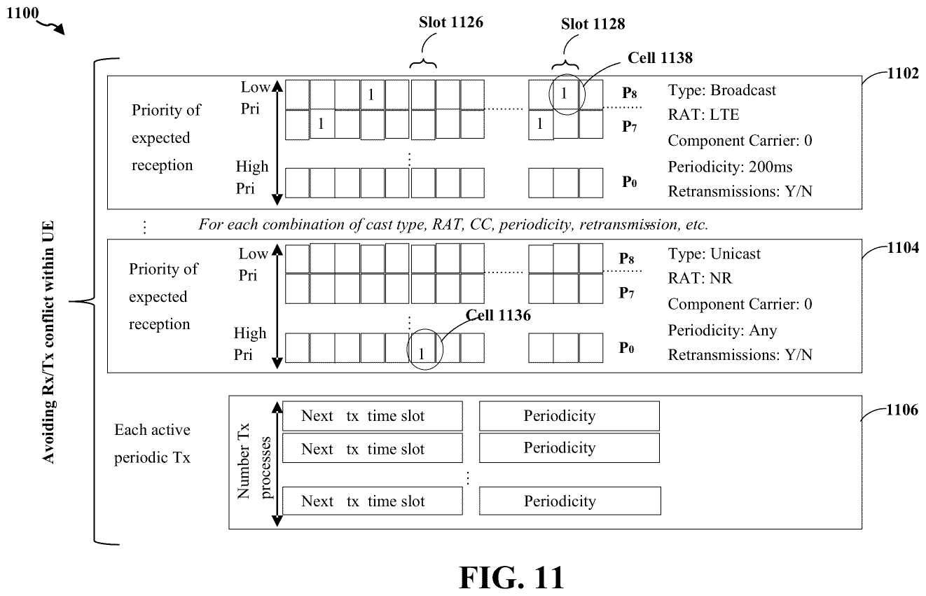

FIG. 11 is a diagram 1100 illustrating data structures used by the UE to keep records of priorities and timeslots of transmissions and receptions at the UE. The data structures can be independently stored by cast type, RAT type, component carrier, periodicity, retransmission type, etc.

Each of the sections 1102 and 1104 represents a data structure for storing data of a different combination of cast type (broadcast, groupcast, unicast), RAT (LTE, NR), Component Carrier (CC), periodicity, retransmission, etc. The section 1102, for example, illustrates a data structure for a broadcast transmission on Carrier 0 in LTE, while the section 1104 illustrates a data structure for a unicast transmission on Carrier 0 in NR.

Each section 1102, 1104 includes a table (e.g., a bitmap). The horizontal axis of each table represents a plurality of time slots. The vertical axis represents a plurality of priorities. A mark “1” in a cell indicates that the corresponding time slot is expected to be occupied by a transmission from another UE with the corresponding priority. A blank cell may be implemented by a “0” to indicate no reception of a corresponding priority is scheduled in the time slot.

For example, in the section 1102, the “1” mark in a cell 1138 indicates that the UE A expects to receive a broadcast transmission with the lowest priority P₈ in a time slot 1128 on LTE. Similarly, in the section 1104, the “1” mark in a cell 1136 indicates that the UE A expects to receive a unicast transmission with the highest priority P₀ in a time slot 1126 on NR.

The UE A uses these data structures to implement the TX strategy described in FIG. 10. Initially, in Stage 1, the UE A excludes all the time slots from the pool of available resources if it is expecting any reception in those time slots, regardless of the priority, cast type, RAT, or carrier. To do this, the UE A checks all the data structures (sections 1102, 1104 in FIG. 11) for any “1” mark in any cell. If a time slot has a “1” mark in any of the data structures, it is excluded from the resource pool.

For example, if the time slot 1128 has a “1” mark in the cell 1138 of the section 1102, indicating an expected broadcast reception with priority P₈ on LTE, and the time slot 1126 has a “1” mark in the cell 1136 of the section 1104, indicating an expected unicast reception with priority P₀ on NR, both the time slots 1128 and 1126 are excluded from the resource pool in Stage 1.

If the percentage of available resources in the pool after Stage 1 is less than the threshold X %, the UE A proceeds to Stage 2. In Stage 2, the UE A adds back into the pool those time slots that are only occupied by broadcast messages with a lower priority than the intended transmission.

To implement this, the UE A checks the data structure for broadcast transmissions (section 1102 in FIG. 11) and identifies the time slots that have a “1” mark only in cells corresponding to priorities lower than the intended transmission. These time slots are added back to the resource pool.

For instance, if the UE A intends to transmit data with priority P₆, and the time slot 1128 has a “1” mark only in the cell 1138 (corresponding to priority P₈) of the section 1102, the time slot 1128 is added back to the resource pool in Stage 2.

If the available resources are still below the threshold after Stage 2, the UE A moves to Stage 3, where it adds back those time slots that contain only broadcast and groupcast messages with lower priority than the intended transmission. The UE A checks the data structures for broadcast and groupcast transmissions and identifies the time slots that have a “1” mark only in cells corresponding to priorities lower than the intended transmission. These time slots are added back to the resource pool.

This process continues through the subsequent stages as described in FIG. 10, with the UE A progressively relaxing the exclusion criteria and adding back more time slots to the resource pool based on the priority and type of expected receptions indicated in the data structures.

The section 1106 illustrates another data structure used by the UE A. Different TX processes within the UE A do not overlap. For each active TX process, the UE A keeps a record of the next transmission time slot and the periodicity. When a new TX process needs to be inserted, the UE A can check this data structure to select resources that do not overlap with resources used by existing processes.

By using these data structures, the UE A can effectively implement the TX strategy described in FIG. 10, minimizing the overlap between its own transmissions and the expected receptions from other UEs, especially those with high priority.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
determining a pool of resources for transmitting data from the UE to another UE over a number of time slots;
determining available resources from the pool of resources by excluding first one or more time slots from the number of time slots based on expected reception at the UE in the one or more time slots;
when a ratio of currently available resources to the pool of resources is less than a threshold, modifying the available resources by adding back a first set of time slots from the excluded time slots to the available resource based on a priority of the expected reception in the one or more time slots; and
transmitting the data to the another UE on a resource selected from currently available resources of the pool.

2. The method of claim 1, wherein the expected reception comprises at least one of:
a broadcast reception;
a groupcast reception; or
a unicast reception.

3. The method of claim 1, wherein the first set of time slots that are added back to the pool contain one or more broadcast receptions with a lower priority than a priority of the data to be transmitted from the UE.

4. The method of claim 3, further comprising:
when a ratio of currently available resources to the pool of resources is less than the threshold after adding back the first set of time slots, further modifying the currently available resources by adding back a second set of time slots containing groupcast receptions with a lower priority than the priority of the data to be transmitted from the UE.

5. The method of claim 4, further comprising:
when a ratio of currently available resources to the pool of resources is less than the threshold after adding back the second set of time slots, further modifying the currently available resources by adding back a third set of time slots containing unicast receptions with a lower priority than the priority of the data to be transmitted from the UE.

6. The method of claim 5, further comprising:
when a ratio of currently available resources to the pool of resources is still less than the threshold after adding back the third set of time slots, further modifying the currently available resources by adding back a fourth set of time slots containing broadcast receptions within a same radio access technology (RAT) as the data to be transmitted from the UE and with a priority equal to or higher than the priority of the data to be transmitted from the UE.

7. The method of claim 6, further comprising:
when a ratio of currently available resources to the pool of resources is less than the threshold after adding back the fourth set of time slots, further modifying the currently available resources by adding back a fifth set of time slots containing groupcast or unicast receptions within the same RAT as the data to be transmitted from the UE and with a priority equal to or higher than the priority of the data to be transmitted from the UE.

8. The method of claim 1, wherein the determining available resources further comprises excluding a second one or more time slots from the pool based on an expected transmission of the UE in the second one or more time slots.

9. The method of claim 8, wherein the expected transmission is determined based on a periodicity of a plurality of periodic transmit processes of the UE.

10. The method of claim 1, wherein the UE maintains a data structure for each combination of at least two of cast type, radio access technology (RAT), component carrier, periodicity, and retransmission type, the data structure indicating time slots and corresponding priorities of expected receptions.

11. The method of claim 10, wherein the UE uses the data structures to determine the first one or more time slots to exclude and to determine time slots to add back to the available resources.

12. The method of claim 1, wherein the UE maintains a data structure for one or more transmit processes of the UE, the data structure indicating a next transmission time slot and a periodicity for the transmit process.

13. The method of claim 12, wherein the UE uses the data structures to determine the second one or more time slots to exclude.

14. The method of claim 1, wherein the UE is a vehicle-to-everything (V2X) UE, and wherein the another UE is a V2X UE.

15. An apparatus for wireless communication, the apparatus being a user equipment (UE), comprising:
a memory; and
at least one processor coupled to the memory and configured to:
determine a pool of resources for transmitting data from the UE to another UE over a number of time slots;
determine available resources from the pool of resources by excluding first one or more time slots from the number of time slots based on expected reception at the UE in the one or more time slots;
when a ratio of currently available resources to the pool of resources is less than a threshold, modify the available resources by adding back a first set of time slots from the excluded time slots to the available resource based on a priority of the expected reception in the one or more time slots; and
transmit the data to the another UE on a resource selected from currently available resources of the pool.

16. The apparatus of claim 15, wherein the expected reception comprises at least one of:
a broadcast reception;
a groupcast reception; or
a unicast reception.

17. The apparatus of claim 15, wherein the first set of time slots that are added back to the pool contain one or more broadcast receptions with a lower priority than a priority of the data to be transmitted from the UE.

18. The apparatus of claim 17, wherein the at least one processor is further configured to:
when a ratio of currently available resources to the pool of resources is less than the threshold after adding back the first set of time slots, further modify the currently available resources by adding back a second set of time slots containing groupcast receptions with a lower priority than the priority of the data to be transmitted from the UE.

19. The apparatus of claim 18, wherein the at least one processor is further configured to:
when a ratio of currently available resources to the pool of resources is less than the threshold after adding back the second set of time slots, further modify the currently available resources by adding back a third set of time slots containing unicast receptions with a lower priority than the priority of the data to be transmitted from the UE.

20. A computer-readable medium storing computer executable code for wireless communication of a user equipment (UE), comprising code to:
determine a pool of resources for transmitting data from the UE to another UE over a number of time slots;
determine available resources from the pool of resources by excluding first one or more time slots from the number of time slots based on expected reception at the UE in the one or more time slots;
when a ratio of currently available resources to the pool of resources is less than a threshold, modify the available resources by adding back a first set of time slots from the excluded time slots to the available resource based on a priority of the expected reception in the one or more time slots; and
transmit the data to the another UE on a resource selected from currently available resources of the pool.
